(19) United States
(12) Patent Application Publication
(10) Pub. No.: US 2014/0114677 A1
(43) Pub. Date: Apr. 24, 2014

(54) Assisted Medical and Associated Lifestyle Decision Making

(71) Applicant: THERANOS, INC., Palo Alto, CA (US)

(72) Inventor: Elizabeth Holmes, Palo Alto, CA (US)

(73) Assignee: THERANOS, INC., Palo Alto, CA (US)

(21) Appl. No.: 14/059,195

(22) Filed: Oct. 21, 2013

Related U.S. Application Data
(60) Provisional application No. 61/717,619, filed on Oct. 23, 2012.

(51) Int. Cl. G06F 19/00

(52) U.S. Cl. CPC G06F 19/322
USPC 705/2

(57) ABSTRACT

Methods, systems, devices, and computer-readable media for generating a location-based physiological history of a subject are provided. Methods may include generating, with the aid of a processor, a location-based physiological history of the subject by correlating geolocation data of the subject with physiological data and exogenous data. The geolocation data may be obtained with the aid of a geolocation system on or associated with the subject. The exogenous data may be of or related to environmental conditions at a geographic location of the subject.

### CROSS-REFERENCE

This application claims the benefit of U.S. Provisional Application No. 61/717,619, filed Oct. 23, 2012, which application is incorporated herein by reference in its entirety.

### BACKGROUND

A person's health and well-being is determined not only by the person's physical attributes (e.g. genetic make-up), but also by the environments the person encounters. For example, if a person is exposed to a high concentration of a virus at the person's workplace, the person may contract an illness. As another example, the person may be exposed to a virus when the person is in proximity to another person that carries the virus.

Conventional methods and systems for diagnosing and/or treating a disease condition suffer a number of profound drawbacks. First, such systems and methods are not capable of drawing a relationship between the subject's environment and the subject's disposition in space and time. For example, if a subject is exposed to a high concentration of a pathogen, the subject is ordinarily not able to detect the exposure and seek measures to prevent the onset of any potential disease condition. Second, approaches for diagnosing and treating the subject are not capable of pinpointing the time point at which the subject was exposed to the virus. Such information may be crucial in identifying the type of pathogen that the subject was exposed to and providing a targeted remedy.

### SUMMARY

In view of the limitations associated with conventional systems and methods for diagnosing and treating a subject, there is a need for systems and methods that enable a subject to assess the impact of the subject's environment on the health or well-being of the subject.

In some embodiments, systems and methods are provided to enable the rapid and automatic integration of geographic location-based history (or geolocation history) of a subject with any one, two, or three of physiological data, personal behavior data or exogenous data to enhance health, medical, and lifestyle decision making, including diagnosis, prognosis, treatment, lifestyle, and travel planning In some cases, such systems and methods take advantage of the realization that many exogenous factors that may impact the health of a subject are location-dependent (also “location-based” herein). By assessing a change in a subject's location as a function of time and assessing physiological, exogenous and/or personal behavior data of the subject at a particular location, systems and methods provided herein enable a determination as to how a subject's environment has impacted, is presently impacting, or may subsequently impact the health (including physiological or mental health) or lifestyle of the subject.

In some embodiments, location-based data provides critical information to characterize and learn about a subject's environment. Additional sources of information can improve the overall interpretation and assessment of the location-based data to characterize a subject's environment, including social networking data, communications, purchasing history, and multimedia data (collectively referred to as “personal behavior data” herein). For example, with information gleaned from a subject's social network, one can further characterize and resolve environmental inputs, such as socialization patterns, the number and age of people likely to be at a social gathering, and the travel patterns of one's social network. Communications information can help characterize the strength, quality, and size of a subject's social network, as well as provide information about a subject's hobbies and activities, such as a training routine for a marathon. Purchasing history provides additional insight into a subject's exogenous and personal behavior inputs, such as a subject's diet, cosmetics and cookbook selections, and exercise routine. Location-based information can be augmented with multimedia data, such as photos, videos, and sound. Such information can characterize the location-based environment, such as weather, air and water quality, flora and fauna, population density, and food options.

In one embodiment, a computer-implemented method for generating a location-based physiological history of a subject is provided, the method including: generating, with the aid of a processor, a location-based physiological history of the subject by correlating geolocation data of the subject with physiological data and exogenous data, wherein the geolocation data is obtained with the aid of a geolocation system on or associated with the subject, and wherein the exogenous data is of or related to environmental conditions at a geographic location of said subject. In some embodiments, the method may further include transmitting the location-based physiological history of the subject to (i) the subject, (ii) a healthcare provider, (iii) an insurance provider, or (iv) a pharmacy. In some embodiments, the method may further include correlating the location-based physiological history of the subject with a location-based physiological history of other subjects.

In another embodiment, a computer-implemented method for generating a location-based physiological history of a subject is provided, the method including: generating, with the aid of a processor, a location-based physiological history of the subject by correlating geolocation data of the subject with physiological data and personal behavior data, wherein the geolocation data is obtained with the aid of a geolocation system on or associated with the subject. In some embodiments, the method may further include correlating exogenous data with said geolocation data, physiological data, and personal behavior data to generate a location-based physiological history, wherein the exogenous data is of or relating to the environment. In some embodiments, the method may further include transmitting the location-based physiological history of the subject to (i) the subject, (ii) a healthcare provider, (iii) an insurance provider, or (iv) a pharmacy. In some embodiments, the method may further include correlating the location-based physiological history of the subject with a location-based physiological history of other subjects.

In another embodiment, a computer-implemented method for generating a location-based physiological history of a subject is provided, the method including: generating, with the aid of a processor, a location-based physiological history of the subject by correlating geolocation data of the subject with personal behavior data and exogenous data, wherein the geolocation data is obtained with the aid of a geolocation system on or associated with the subject, and wherein the exogenous data is of or related to environmental conditions at a geographic location of the subject.

In another embodiment, a computer-implemented method for generating a location-based physiological history of a subject is provided, the method including: generating, with the aid of a processor, a location-based physiological history of the subject by correlating geolocation data of the subject with any two of physiological data, exogenous data and personal behavior data, wherein the geolocation data is obtained with the aid of a geolocation system on or associated with the subject.

In another embodiment, a computer readable medium including machine-executable code implementing a method for generating a location-based physiological history of a subject is provided, the method including: generating, with the aid of a processor, a location-based physiological history of the subject by correlating geolocation data of the subject with physiological data and exogenous data, wherein the geolocation data is obtained with the aid of a geolocation system on or associated with the subject, and wherein the exogenous data is of or related to environmental conditions at a geographic location of the subject.

In another embodiment, a computer readable medium comprising machine-executable code implementing a method for generating a location-based physiological history of a subject is provided, the method including: generating, with the aid of a processor, a location-based physiological history of the subject by correlating geolocation data of the subject with physiological data and personal behavior data, wherein the geolocation data is obtained with the aid of a geolocation system on or associated with the subject.

In another embodiment, a health monitoring device is provided, the device including: a housing; a geolocation module within the housing, the geolocation module configured to obtain geolocation data at one or more geographic locations of a subject; and a point of service module within the housing, the point of service module configured to detect the concentration of an analyte in a biological sample of the subject at said one or more geographic locations. In some embodiments, the health management device may further comprise another module for obtaining exogenous data. In some embodiments, the health management device further includes a graphical user interface (GUI) configured to display to the subject i) the geolocation data, ii) the physiological data, or iii) the location-based physiological history of the subject.

In some embodiments, a health monitoring system is provided, the system including: a health management device, comprising: i) a geolocation module configured to obtain geolocation data, the geolocation data including geographic locations of a subject; and ii) a point of service module configured to obtain physiological data from the subject; a server operatively linked to the health management device, the server configured to collect the geolocation data and physiological data from the health management device, wherein the server is configured to correlate, with the aid of a processor, the geolocation data with the physiological data and the exogenous data, the exogenous data of or related to environmental conditions at the geographic locations.

In another embodiment, a health monitoring system is provided, the system including: a computer system configured to correlate, with the aid of a processor, geolocation data of a subject with any two of physiological data, exogenous data and personal behavior data, thereby aiding in diagnosis, prognosis or treatment of a disease condition of the subject, wherein the geolocation data is of or related to geographic locations of the subject, wherein the exogenous data is of or related to environmental conditions at the geographic locations, and wherein the physiological data and personal behavior data are of or related to the subject.

In another embodiment, a method for providing a warning concerning the health of a subject is provided, the method including: correlating, with the aid of a processor, geolocation data of the subject with physiological data and exogenous data, the exogenous data related to an environmental condition of a location in which the subject resides or plans to visit; and providing the warning concerning the health of the subject based on the correlation when the correlation is statistically significant, wherein the physiological data is collected during or subsequent to the visit to the location.

In some embodiments, in a system, device, method or computer readable medium described above or elsewhere herein involving a method for generating a location-based physiological history of a subject, the method is to aid in diagnosis, prognosis or treatment of a disease condition.

In some embodiments, in a system, device, method, or computer readable medium described above or elsewhere herein involving physiological data and geolocation data, the physiological data is matched through time stamp or other identifier to the geolocation data.

In some embodiments, in a system, device, method, or computer readable medium described above or elsewhere herein involving physiological data, the physiological data is obtained with the aid of a point of service system on or associated with a subject.

In some embodiments, in a system, device, method, or computer readable medium described above or elsewhere herein involving physiological data, the physiological data is obtained at a geographical location of a subject.

In some embodiments, in a system, device, method, or computer readable medium described above or elsewhere herein involving physiological data, the physiological data includes at least one of protein concentration, blood pressure, breathing pattern, white blood cell count, red blood cell count, heart rate, body temperature, blood pressure, DNA/RNA expression, drug concentration, skin conductivity, amount of hand tremors, or metabolite concentration.

In some embodiments, in a system, device, method, or computer readable medium described above or elsewhere herein involving exogenous data of or related to environmental conditions at a geographic location of a subject, the exogenous data is collected before, during, or after the subject's visit to the location.

In some embodiments, in a system, device, method, or computer readable medium described above or elsewhere herein involving exogenous data, the exogenous data includes at least one of: temperature, air pressure, humidity, dew point, wind speed, food consumed by the subject, or concentration of allergens, pollen, pathogens, carbon monoxide, or toxins.

In some embodiments, in a system, device, method, or computer readable medium described above or elsewhere herein involving geolocation data, the geolocation data is obtained with the aid of a geolocation system on or associated with the subject.

In some embodiments, in a system, device, method, or computer readable medium described above or elsewhere herein involving a geolocation system, the geolocation system uses wireless triangulation or a global positioning system (GPS).

In some embodiments, in a system, device, method, or computer readable medium described above or elsewhere herein involving a geolocation system, the geolocation system is configured to obtain exogenous data or physiological data from a subject.

In some embodiments, in a system, device, method, or computer readable medium described above or elsewhere herein involving personal behavior data, the personal behavior data is collected from at least one source selected from the group consisting of a social network, the Internet, a communications repository, a retailer, a multimedia repository, a bank, or a credit union.

In some embodiments, in a system, device, method, or computer readable medium described above or elsewhere herein involving personal behavior data, the personal behavior data is obtained from a communications device or multimedia device of or associated with a subject.

In some embodiments, in a system, device, method, or computer readable medium described above or elsewhere herein involving a communications device or multimedia device, the communications device or multimedia device is portable.

In some embodiments, in a system, device, method, or computer readable medium described above or elsewhere herein involving personal behavior data, the personal behavior data includes at least one of social networking data, communications data, purchasing history, or multimedia data.

In some embodiments, in a system, device, method, or computer readable medium described above or elsewhere herein involving communications data, the communications data is selected from the group consisting of short message service (SMS) text messaging, multimedia message service (MMS) text messaging, phone conversations, or instant messaging.

In some embodiments, in a system or device provided herein, the system or device includes one or more sensors configured to detect exogenous data.

In some embodiments, a system or device provided herein is configured to generate health information related to a subject.

In some embodiments, a system or device provided herein includes a graphical user interface (GUI) configured to display to a subject i) geolocation data, ii) physiological data, or iii) location-based physiological history of the subject.

In some embodiments, in a system or device provided herein including a computer system, the computer system is operatively linked to a health management device configured to obtain physiological data from a subject.

In some embodiments, a system or device provided herein includes a geolocation module for collecting geolocation data.

In some embodiments, a computer system provided herein is configured to collect said any one, two, or three of physiological data, exogenous data and personal behavior data.

In some embodiments, in a system provided herein including a computer system, the system includes a housing containing the computer system.

In some embodiments, in a system or device provided herein including a housing, geolocation data is collected with the aid of a geolocation module in the housing.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### INCORPORATION BY REFERENCE

All publications, patents, and patent applications mentioned in this specification are herein incorporated by reference to the same extent as if each individual publication, patent, or patent application was specifically and individually indicated as incorporated by reference.

### BRIEF DESCRIPTION OF THE DRAWINGS

In the drawings,

FIG. 1 shows a workflow to aid in medical and assisted lifestyle decision making;

FIG. 2 shows a plot illustrating a method provided herein for monitoring the health or well-being of a subject;

FIG. 3 schematically illustrates a health-management device provided herein; and

FIG. 4 schematically illustrates a health-management or monitoring system provided herein.

FIG. 5 provides examples of how various types of data may be correlated.

### DETAILED DESCRIPTION

While various embodiments have been shown and described herein, such embodiments are provided by way of example only. Numerous variations, changes, and substitutions may occur to those skilled in the art without departing from the disclosures provided herein.

The term “health care provider,” as used herein, refers to a doctor or other health care professional providing medical treatment and/or medical advice to a subject. A health care professional may include a person or entity that is associated with a health care system. Examples of health care professionals may include physicians (including general practitioners and specialists), surgeons, dentists, audiologists, speech pathologists, physician assistants, nurses, midwives, pharmacists, dietitians, therapists, psychologists, chiropractors, clinical officers, physical therapists, phlebotomists, occupational therapists, optometrists, emergency medical technicians, paramedics, medical laboratory technicians, medical prosthetic technicians, radiographers, social workers, and a wide variety of other human resources trained to provide some type of health care service. A health care professional may or may not be certified to write prescriptions. A health care professional may work in or be affiliated with hospitals, health care locations and other service delivery points, or also in academic training, research and administration. Some health care professionals may provide care and treatment services for patients in private or public domiciles, community centers, gathering places or mobile units. Community health workers may work outside of formal health care institutions. Managers of health care services, medical records and health information technicians and other support workers may also be health care professionals or affiliated with a health care provider. A health care professional may be an individual or an institution that provides preventive, curative, promotional or rehabilitative health care services to individuals, families, or communities.

The term “subject” as used herein, refers to an individual whose health is being monitored, diagnosed, or treated, or an individual who is in need of monitoring, diagnosis, or treatment.. In some instances, a subject is under the care of, or being acted upon by, a point of care system. A subject may include a patient. In some cases, the subject is a human patient.

The term “location” as used herein, refers to a location or place where a subject resides or visits. A location may be a continent, country, region, province, state, county, city, town, or other environment. A location may be characterized by a longitude and latitude, and in some cases, an altitude. A location may be further specified, such as commercial store, restaurant, place of work, private resident, park, airplane, train, etc. A location may be a static location which may remain at the same geolocation. Alternatively, the location may be a dynamic location which may have a relatively moving geolocation.

The term “point of service system,” as used herein, refers to a system that is capable of providing a service (e.g. testing, monitoring, treatment, diagnosis, guidance, sample collection, ID verification, medical services, non-medical services, etc.) at or near the site or location of the subject. In some situations, a point of service system provides a service at a predetermined location, such as a subject's home or work, grocery stores, drug stores, clinics, schools, etc. A point of service system can include one or more point of service devices. In some embodiments, a point of service system is a point of care system. A “point of care system” refers to a system that is capable of providing medical-related care (e.g. treatment, testing, monitoring, diagnosis, counseling, etc.) at or near the site or location of the subject (e.g. at a subject's home or work, grocery stores, drug stores, clinics schools, etc.).

The term “social network,” as used herein, refers to one or more individuals or entities associated with a subject in a social setting. In some instances, certain aspects of a subject's social network are revealed with the aid of social network providers having software operating on one or more computer systems, such as web-enabled software. Examples of such social network providers include Facebook®, Linkedln®, Twitter®, Google+® and the like. In other instances, a subject's social network may be collected or assessed with the aid of hardware and/or software configured to search various sources having information related to a subject's social interactions, such as, for example, a contact list, communications history, employee roster, organizational roster, web history, or search history.

The term “personal behavior data,” as used herein, refers to communications data, social networking data, purchasing data (e.g., purchasing history), and multimedia data. The communications data may include short message service (SMS) text messages, multimedia message service (MMS) text messages, transcripts of phone conversations or instant messaging transcripts, or transcripts of communications made using other communications protocols. Examples of personal behavior data include social network status updates (e.g., “Today, I am feeling sick”), text messages, electronic mail communications, and World Wide Web browsing history (or pattern). In some instances, personal behavior data provide perspective on the subject's physical or mental condition, or the subject's assessment of an environment that the subject has visited, is presently visiting, or plans to visit.

The term “exogenous data,” as used herein, refers to information and factors that are external to the subject, including environmental conditions. In some embodiments, exogenous factors (or data) are related to factors and/or entities that are external to a subject under monitoring or treatment, but that may impact the health or well-being of the subject. Examples of exogenous data include pollen concentration, allergen concentration, pathogen concentration, air pollution concentration, temperature, air pressure, humidity, dew point, wind speed and/or strength, sun coverage (including intensity, luminosity), ultraviolet (“UV”) index, and other measurable qualities of the environment. In some cases, the exogenous data includes food, drink or other consumables served to and/or consumed by the subject. In some situations, the food, drink, or other consumables are exposed to the subject (e.g., ingested) at the geographic location.

In one example, an exogenous factor is an environmental condition, such as temperature. In another example, an exogenous factor is a group of individuals at an airport. In some instances, exogenous factors are captured, at least in part, by a subject's lifestyle factors (e.g., heavy drinking is illustrative of alcohol ingestion), which may impact a subject's health or well-being. In an example, a subject's lifestyle factors include: the subject bikes 20 miles outdoors on average two times per week; the subject spends one hour at a gym every week; the subject sleeps on average seven hours every night; the subject travels to work by walking 3 blocks and taking a train; the subject eats dinner out 3 times per week; the subject purchases groceries once a month at a high quality grocery store and weekly at a farmers market; the subject spends approximately 3 hours per week at bars, so is likely to consume at least 3 alcoholic beverages per week; the subject is at work on average 60 hours per week; and the subject typically remains stationary for long periods of time at work.

The term “physiological data,” as used herein, refers to the health, mental or physiological state of a subject. Examples of physiological data include, without limitation, protein concentration, blood pressure, breathing pattern (or rate), white blood cell count, red blood cell count, heart rate, stress level, body mass index (BMI), body temperature, conductivity, mood and mental state (e.g., depression). In some embodiments, the physiological data may include an image of the subject and/or a sample collected from the subject. The physiological image may include the weight of the subject, hair, facial images, and/or body position/posture images. Physiological data may include information regarding any analyte of interest from a subject. The physiological data may be measured at a location of the subject. The physiological data may be time-stamped, to enable correlation. The time-tracked physiological data may enable comparison of physiological data over time. For example, analyte levels, biomarker levels, weight loss/gain, hair loss/gain, graying, facial aging, changes in posture may be tracked and/or analyzed.

The term “geolocation data,” as used herein, refers to information of or related to the geographic location (or position) of a subject. Geolocation data may include timestamp, longitude, latitude and/or altitude.

The term “cloud computing” (or “cloud”), as used herein, refers to a system in which shared resources, software and information are provided to computers and other devices as a utility over a network, such as the Internet. Shared resources may include various computer systems, such as servers, that may be provided in a distributed fashion but operatively coupled to one another. In an example, servers are operatively coupled to one another through a network, such as an intranet or the Internet. Servers may include network interfaces for communicating with an intranet or the Internet. In some situations, servers include communications interfaces (e.g., a Bluetooth interface) for communicating with other servers or other devices.

The health of a subject may depend on various exogenous factors. For instance, a subject's health may be impacted by environmental factors or conditions, such as, for example, an air-borne, water-borne, or food-borne pathogen. In another example, a subject's health may be impacted by other individuals at a given location, such as a group of sick individuals that may transmit a virus from one another. Environmental factors that can influence health are numerous. Such factors may include allergens, pathogens, medications, toxins and lifestyle factors. Exemplary pathogens include, but are not limited to, viruses, bacteria, prions, protozoans, single-celled organisms, algae, eggs of pathogenic organisms, microbes, cysts, molds, fungus, worms, amoeba, pathogenic proteins, parasites, algae, and viroids.

It is ordinarily difficult to correlate the health or well-being of a subject with the limitless number of environmental conditions that may impact the subject's health or well-being. This is due in part to the fact that a subject's location changes, and with each change in location the environmental conditions impacting the subject may change. In some instances, exogenous factors are critical for optimal medical and associated lifestyle decision making However, correlating such factors with the health of a subject is typically difficult, at least in part due to the challenges of rapid, robust, and reliable data collection, synthesis and analysis.

In some embodiments, systems and methods are provided that advantageously monitor the location of a subject and correlate the subject's location with one or more, two or more, or all three of the following: physiological data, exogenous data and/or personal behavior data. This enables the subject or health care provider to assess the impact of various environment conditions on the health or well-being of the subject. In some instances, this may enable the subject to monitor the subject's health or well-being, or to provide a predictive assessment of the subject's health or well-being. In some embodiments, one or more, two or more, three or more, or all four of the following may be monitored and/or correlated: location data, physiological data, exogenous data and/or personal behavior data. Such data may be monitored and/or trended over time. Changes in such data may be analyzed.

Systems and methods provided herein are at least partially based on the realization that the health of a subject may depend on the history and interplay between various factors, as well as their predicted future trajectories. Systems and methods provided herein enable medical diagnosis, prognosis, and treatment decision making by measuring physiological factors, including physiological and biological characteristics of a subject. Such measurements can be univariate or multivariate, cross-sectional or longitudinal, and referenced to prior time points in the same subject and/or population distributions to assist in medical decision making and associated lifestyle choices.

In some instances, family history and patient history are integrated into the decision-making process by augmenting knowledge of physiological factors. In some instances, knowledge of exogenous factors (environmental inputs) is also integrated into the decision-making process.

Some embodiments provide systems and methods by which environmental factors are collected and correlated with a subject's location and optionally, other factors (e.g., physiological factors). This information can be used to enhance medical and lifestyle decision making of the subject, such as by generating a predictive assessment of the subject's health condition in view of various factors at the location of the subject. In an example, the information is used to predict the progression of the health or well-being of a subject. In another example, the information is used to determine the cause of a sickness of a subject.

### Methods

In some embodiments, provided herein are computer-implemented methods for generating a location-based physiological history of a subject to aid in diagnosis, prognosis and/or treatment of a disease condition of the subject. The computer-implemented methods may comprise generating, with the aid of a processor, a location-based physiological history of the subject by correlating geolocation data of the subject with physiological data and exogenous data. The geolocation data may be obtained with the aid of a geolocation system on or associated with the subject. The exogenous data may be of or related to environmental conditions at a geographic location of the subject.

In some embodiments, a device may be provided to aid in the capturing of a subject's geolocation. In some instances, the device may be on loan to another individual, or stolen. Algorithms may be used to identify spurious trends in the data. Such data can be rejected and/or confirmed by the subject. Devices can be configured to require a secure log-in by the subject. Failure to confirm the identity would negate the geolocation data. Furthermore, biometrics, facial recognition, gesture recognition, and/or voice recognition can be used to further confirm the user of the device.

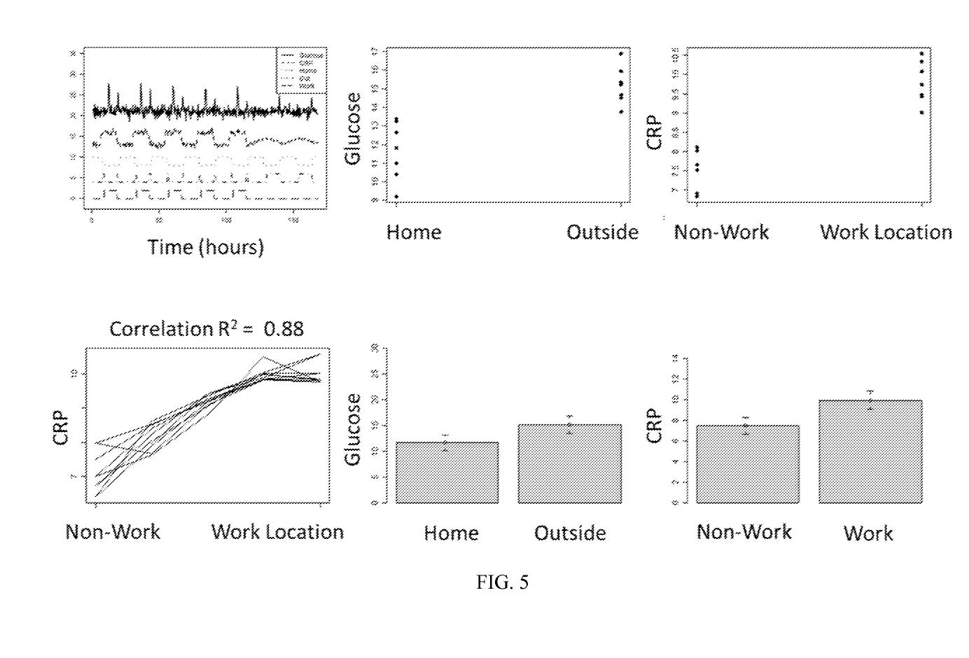

FIG. 5 provides examples of how data is correlated. The example shows two physiologic measurements (Glucose, CRP) and coincident location-based data (“home”, “work” and “outside” locations) measured over the course of a week. Time series analysis reveals that glucose levels are higher when eating outside the home, while CRP values are higher in the work. Correlation of analyte levels, biomarkers, or any other physiologic conditions may be made with other types of data, such as geographic location, exogenous location, and/or personal behavior data. In some embodiments, one or more of geolocation data, physiological data, exogenous data and personal behavior data are correlated with each other. In an embodiment, geolocation data is correlated with one or more of physiological data, exogenous data and personal behavior data. In another embodiment, personal behavior data is correlated with geolocation data, physiological data and exogenous data. In another embodiment, physiological data is correlated with geolocation data, exogenous data and personal behavior data. In another embodiment, exogenous data is correlated with geolocation data, physiological data and personal behavior data.

In some embodiments, a location-based physiological history of a subject is generated by correlating geolocation data of the subject with two or more of physiological data, exogenous data and personal behavior data. In some instances, the correlation is selected from time-series analysis, survival analysis and pattern recognition. In some cases, the correlation involves the use of classification (e.g., support vector machines), clustering (e.g., hierarchical clustering, k-nearest neighbor), regression (e.g., neural networks), and/or probabilistic graphical models (e.g., Bayesian and Markov networks, collaborative filtering ensemble methods, and image analysis).

In some embodiments, the location-based physiological history of the subject is generated by correlating the geolocation data of the subject with physiological data and personal behavior data of the subject. In some instances, the exogenous data is correlated with the geolocation data, physiological data, and personal behavior data to generate a location-based physiological history, wherein the exogenous data is of or relating to the environment.

In some embodiments, a location-based physiological history is generated by correlating geolocation data of the subject with personal behavior data and exogenous data. The personal behavior data may provide information as to any impact of exogenous data on the health or well-being of the subject. In an example, a subject's Facebook® or Linkedin® status update indicates that the subject became sick following the subject's visit at a geographic location.

In some cases, physiological data is obtained with the aid of a point of service system on or associated with said subject (see below). The point of service system may be configured to collect a tissue or fluid sample from the subject and (a) to perform at least one sample preparation procedure selected from the group consisting of sample processing, centrifugation, magnetic separation, and chemical processing, and/or (b) at least one or multiple types of assays selected from the group consisting of immunoassay, nucleic acid assay, receptor-based assay, cytometric assay, colorimetric assay, enzymatic assay, electrophoretic assay, electrochemical assay, spectroscopic assay (e.g., mass spectrometry, infrared spectroscopy, x-ray photoelectron spectroscopy), chromatographic assay, microscopic assay, topographic assay, calorimetric assay, turbidmetric assay, agglutination assay, radioisotope assay, viscometric assay, coagulation assay, clotting time assay, RNA expression array, protein synthesis assay, histological assay, culture assay, osmolarity assay, antigen assay, antibody assay, genotyping assay, and/or other types of assays or combinations thereof. In some embodiments, the point of service system is as described in U.S. patent application Ser. No. 13/244,947 to Holmes et al. (“SYSTEMS AND METHODS FOR MULTI-ANALYSIS”), the content of which is incorporated herein in its entirety.

In some cases, the point of service system is a stationary (e.g., bench-top) or mobile system. In some instances, the point of service system is a patch configured to be carried by the subject or attached to a body part (or region of the body) of the subject. In an example, the point of service system is a patch configured to be attached to the skin of the subject. The patch may be configured for attachment to a body part (e.g., arm, wrist) of the subject. In other instances, the point of service system comprises one or more pills or particles (e.g., nanoparticles) configured to be ingested by the subject and communicate with a control system in proximity to the subject or at a remote location. Examples of other devices and systems, such as patches that may be used with systems and methods provided herein are included in U.S. Patent Publication No. 2005/0100937 (“MEDICAL DEVICE FOR ANALYTE MONITORING AND DRUG DELIVERY”), the content of which is incorporated herein in its entirety.

The point of service system may utilize one or more imaging device that may capture an image of the subject, a portion of the subject, or a sample collected from the subject. The images may be captured over time. Physiological data of the subject, such as weight loss/gain, changes in circumference, changes in height, hair loss/gain, graying, facial aging, facial expressions, changes in posture, tissue/cell morphology, or body temperature may be monitored and/or analyzed. Such physiological data may be correlated with other types of data.

In an embodiment, the physiological data is obtained at a geographical location of the subject. In some cases, the physiological data is obtained at a predetermined, user-defined or system-defined interval (or upon request by a user or system) at a location in which the subject resides. In other cases, the physiological data is obtained continuously, or continuously within a predetermined interval. In an example, the subject moves from a first location to a second location, and physiological data is obtained from the subject at each of the first and second locations.

In some instances, the location-based physiological history of the subject is transmitted to (i) the subject, (ii) a healthcare provider, (iii) an insurance provider, (iv) a pharmacy, or (v) an authorized recipient. In some cases, the location-based physiological history is transmitted to a server, which may provide the history for access by authorized users. In some cases, the subject selects access restrictions that provide one or more users access to the subject's location-based physiological history.

In some embodiments, the location-based physiological history of the subject is correlated with a location-based physiological history of another subject. In an example, if a first subject has experienced a change in the first subject's well-being, the cause of the change may be determined by reviewing a location-based physiological history of a second subject for exogenous factors that have a likelihood of impacting the health or well-being of the first subject. The first and second subjects may have visited the same location at the same time or at different points in time, but a potential cause of the first subject's change in well-being may be determined by correlating exogenous data from the location with physiological or personal behavior data of the second subject.

The personal behavior data may be collected from at least one source selected from a social network, the Internet, a communications repository, a retailer, a multimedia repository, a bank or credit union. The personal behavior data may be obtained from a communications device and/or multimedia device of or associated with the subject. The communications device and/or multimedia device may be a portable device. A portable device may be a tablet personal computer (PC) (e.g., Apple iPad, Android-enabled tablet, Samsun Galaxy, Blackberry tablet), slate PC, Smart phone (e.g., Apple iPhone, Android-enabled phone), laptop PC, or GPS device.

Some embodiments provide computer-implemented methods for generating a location-based physiological history of a subject to aid in diagnosis, prognosis and/or treatment of a medical (e.g., disease) condition. In some cases, this comprises generating a location-based physiological history of the subject by correlating geolocation data of the subject with 1) exogenous data, 2) personal behavior data, 3) physiological data, 4) physiological data and exogenous data, 5) physiological data and personal behavior data, 6) exogenous data and personal behavior data, or 7) physiological data, exogenous data and personal behavior data. The location-based physiological history may be used to aid in diagnosis, prognosis, treatment of a disease condition, and/or provide information for a health-monitoring system.

In an example, upon a subject's visit to a location, a geolocation device of the subject measures, with the aid of GPS or other global navigation satellite system, a location of the subject and records the subject's location and timestamp at which the location was recorded. A health management system (e.g., a server having one or more processors) coupled to the geolocation device, such as through a network, retrieves the location information (geolocation data) from the geolocation device and retrieves exogenous data associated with the location, which relates to a point in time or period of time prior to, during, or both prior to and during the subject's visit to the location. For example, the health management system retrieves the pollen concentration at the location at the point in time corresponding to the timestamp. In some cases, the location information is stored on the geolocation device and transmitted to the health management system at a later point. The health management system may then determine whether the pollen concentration is above a predetermined threshold, which might increase the subject's chance of having an allergic reaction to the pollen. If the pollen concentration is above the predetermined threshold, the health management device may send a warning to the subject. In the instant example, the system correlates the geolocation data with the exogenous data to determine whether the subject is at risk of having an allergic reaction to the pollen.

In some embodiments, geolocation data is collected at discrete time points, such as, for example, at an interval between about 1 second and 60 minutes, or 10 seconds and 30 minutes, or 30 seconds and 15 minutes. In some situations, geolocation data is collected at discrete time points every minute, every ten minutes, or every hour. In some cases, the geolocation data is collected continuously. In other cases, geolocation data is collected upon request by a subject.

In some cases, the geolocation data comprises a longitude and latitude. In other cases, the geolocation data comprises a longitude, a latitude and an altitude. In some cases, the geolocation data is collected using wireless triangulation. In an example, wireless triangulation uses IEEE 802.11 standards to determine the location of a subject. In other situations, the geolocation data may be collected using a global positioning system (GPS). The global positioning system may use signals from 2, 3, or 4 or more satellites to determine the location of the device having the global positioning system. A geolocation system may also or alternatively utilize street cameras, cameras on computers, tracking devices on automobiles, cell phone towers, or wide area information server (WAIS). Some devices may record driving habits. Location can also be inferred from multiple activities that suggest location, such as logging into computers/networks having a defined location, or by personal behavior data such as credit card purchases at a particular store location.

In some embodiments, the exogenous data is collected with a system on or associated with said subject. The system may be a device capable of collecting exogenous data and geolocation data, exogenous data and physiological data, all three or some other combination of data. For example, the device may be able to measure ambient temperature or allergen concentrations in the environment, including air. Alternatively, the system may collect exogenous data from third party databases or information collectors (e.g., data mining systems, servers with crawlers). The system in such cases may include data mining systems and software for collecting such information. For example, the device may access a database to obtain the temperature, UV index or wind speed at the geographic locations the subject has visited. In some cases, the system includes software and in some cases hardware configured to collection information in a self-learning fashion. In an example, the system can learn from a subject's network activity (e.g., web sites frequently visited) and collect personal behavior data and exogenous data from the subject's network activity.

In some instances, the physiological data is obtained by or measured with a system on or associated with the subject. The system may utilize one or more devices. In some cases, the system includes a device the subject carries for other purposes not directly related to the subject's health, such as a watch, smart phone, portable PC or tablet PC. Such a device may be configured to measure a geolocation of the subject.

The system may obtain physiological data through an application on such a device. In an example, the device measures heart rate in an application by communicating with a strap or patch in proximity to the subject, and transmits the information to another device, such as a server. The physiological data may be obtained with a point-of-service system.

In some embodiments, the personal behavior data is collected from a social network, the Internet, a communications repository, a retailer, a multimedia repository and/or a credit union. In some embodiments, the personal behavior data comprises purchasing history, communications, social network information and/or multimedia. In some situations, the personal behavior data is collected using a system on or associated with the subject. The system may include a device the subject carries with them, for example a Smart phone. The system may include a personal computer, telephone and/or camera. In some examples, the system collects information from one or more devices and wirelessly transmits it to a server. Alternatively, the system may collect personal behavior data when the subject's phone, camera, and/or tablet device is connected to a computer, and/or when the subject's computer or personal computing device connects to the Internet.

In some embodiments, the geolocation system obtains geolocation data. In some cases, the geolocation system is also configured to obtain exogenous data, physiological data and/or personal behavior data from the subject. For example, if the geolocation system includes a portable electronic device, the device may be configured to communicate with other devices capable of collecting exogenous data, physiological data and/or personal behavior. For example, the geolocation system may include a smart phone application that records the subject's location using the GPS of the Smart phone or via wireless triangulation, collects physiological data from a strap, patch or by communicating with a point of service system, collects exogenous data from a server, and collects personal behavior data from the subject's use of the Smart phone.

In some embodiments, the location-based physiological history is transmitted, such as to a server or the cloud (which may include one or more servers), after it is generated. For example, the location-based physiological history is transmitted to the subject, a healthcare provider, an insurance provider and/or a pharmacy. The location-based physiological history may be generated on a server, and then transmitted to a cloud accessible to entities with certain log-in information or credentials. In an example, the subject, the subject's doctor, a healthcare provider, an insurance provider and/or a pharmacy have access to the cloud to obtain said subject's location-based physiological history.

The geolocation system may correlate geolocation data with one or more, two or more, or all of exogenous data, physiological data or personal behavior data. In some situations, such correlation is implemented on a server remote from the geolocation system. In such a case, data may be transmitted to the server, and the correlation may be implemented on the server.

In some embodiments, the location-based physiological history of a first subject is correlated with and/or compared to the location-based physiological history of a second subject. The two subjects may be related (e.g., family members), co-inhabitants, roommates, passengers, co-workers, etc. In some instances, the two subjects are related based on their geolocation data. For example, they may have visited and/or may frequent the same geographic location(s). In other cases, the two subjects are related based on their physiological data. For example, they may have the same condition and/or symptoms and/or their measured physiological data may be similar. In other cases, the two subjects are related in other ways tangential to the data collection described herein. For example, they may be the same age, same weight and/or have a similar health history. The two subjects may or may not be related. The subjects may or may not have similar genotypes. The subjects may or may not have a subset of homologous genes.

In some embodiments, the correlation of two subjects' location-based physiological histories may be further correlated with the location-based physiological history of a third subject, fourth subject or more subjects. In some situations, location-based physiological histories of entire populations may be correlated. The population may be the population of an area, the population that has visited a specific location, the population of a certain age or weight, the population with a specific physiological condition or symptom, the population with similar physiological data, the population that is connected on a social network, the population that frequents specific businesses or purchases certain items, or a population that is defined by other characteristics.

In some situations, any of geolocation data, physiological data, exogenous data and personal behavior data of a first subject is correlated with (e.g., compared to) any of geolocation data, physiological data, exogenous data and personal behavior data of a second subject. In other instances, the geolocation data and any of physiological data, exogenous data and personal behavior data of a first subject is correlated with the geolocation data and, in some cases, any of physiological data, exogenous data and personal behavior data of a second subject.

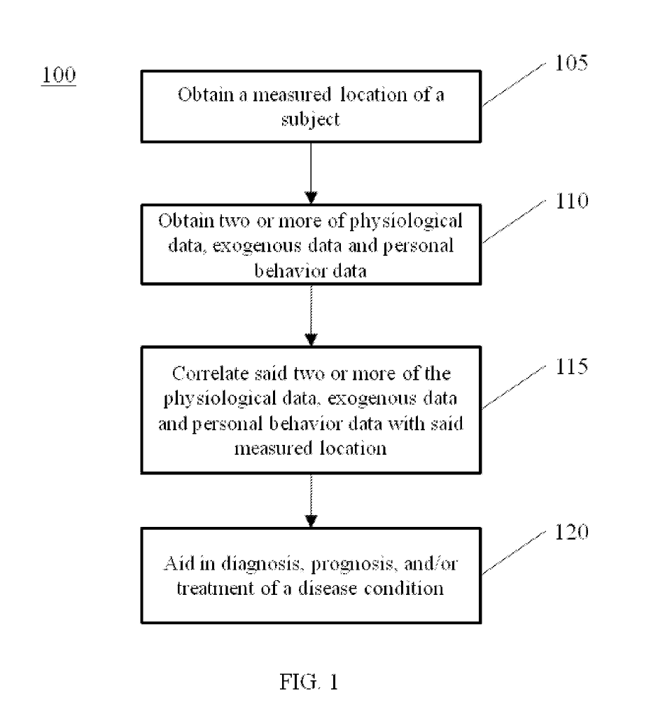

FIG. 1 shows a method 100 provided herein for monitoring the health of a subject. The method 100 may be implemented by a health management system. In a first step 105, the health management system obtains a measured location of the subject. The measured location includes a geolocation of the subject. Next, in a second step 110, two or more of physiological data, exogenous data and personal behavior data are obtained. In some cases, only exogenous or personal behavior data is obtained; physiological data in such cases may not be obtained. The exogenous data is of or related to the geolocation of the subject. Next, in a third step 115, the two or more of the physiological data, exogenous data and personal behavior data, as collected in the second step 110, are correlated with the measured location obtained in the first step 105. In a fourth step 120, the system aids a subject in diagnosis, prognosis, and/or treatment of a disease condition. In some embodiments, the system provides the subject dietary and/or lifestyle options to prevent an ailment or sickness (i.e., preventative measures). In other embodiments, the system provides the subject dietary and/or lifestyle options for overcoming a sickness or ailment (i.e., treatment measures), or mitigating the effects of the sickness or ailment.

Methods and systems provided herein may be used to provide health or life-style related warnings to subjects. In some embodiments, a method for providing a warning concerning the health of a subject comprises correlating, with the aid of a processor, geolocation data of said subject with physiological data and exogenous data. The exogenous data is related to an environmental condition at a location in which said subject visited, is presently visiting or plans to visit. Next, if the correlation is statistically significant, a warning is provided to the subject concerning the health of the subject based on the correlation. The subject may visit the location for any period of time, such as for at least about 1 second, or 2 seconds, or 3 seconds, or 4 seconds, or 5 seconds, or 10 seconds, or 30 seconds, or 1 minute, or 10 minutes, or 30 minutes, or 1 hour, or 12 hours, or 1 day, or 1 week, or 1 month, or 1 year, or more. In some cases, the exogenous data is collected before, during or after the subject's visit to the location, but is related to the location (e.g., the pollen concentration at the location at a particular point in time).

The physiological data may be collected before, during, or subsequent to the visit to the location. The exogenous data may be collected before or during the subject's visit to the location. In some cases, the exogenous data may be obtained after the subject's visit to a location, but concerns environmental conditions before or during the subject's visit to the location. In some cases, the exogenous data is obtained from a database. In other cases, the exogenous data is obtained via wireless communication with other devices (e.g., environmental sensors) that are configured to collect exogenous data.

In an example, the exogenous data is related to the subject's health. For example, the exogenous data may comprise temperature if the subject is sensitive to heat or cold, UV index if the subject is susceptible to or has skin cancer or another disorder relating to the sun, pollen or other allergen concentrations if the subject is allergic to pollen or other allergen, or other information potentially relating to, or capable of affecting, the subject's health.

The physiological data may be collected during or subsequent to the visit to the location. The physiological data may be related to the exogenous data. The physiological data may be collected as a result of the observation of certain exogenous data. For example, the physiological data may relate to an allergic reaction if an allergen concentration exceeds a predetermined limit. In some cases, the physiological data is unrelated to the exogenous data, but still provides a statistically significant correlation and aids in providing a warning concerning the health of the subject.

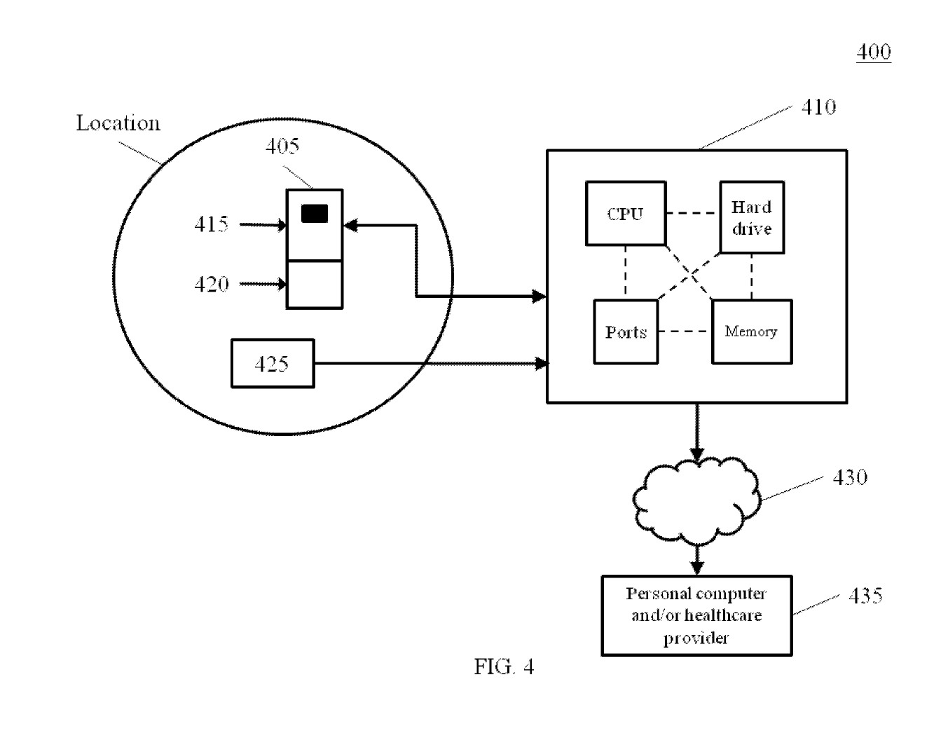

In some embodiments, the physiological data and exogenous data are correlated with the aid of a processor on a device. The device may be a portable electronic device, such as an iPhone or a personal computer. The correlation may be performed using an application or other software downloaded on the subject's device. In other cases, the device is computer system having one or more servers. In some situations, the device may obtain the physiological and exogenous data from other devices or sources. For example, the physiological data may be obtained using a point of care system, and the exogenous data may be obtained from a database or from a device capable of collecting information of or relating to the environment (see FIG. 4). In some cases, if the correlation is statistically significant, the device displays a warning, such as a warning (e.g., “You have a 50% chance of getting the flu”) on a graphical user interface of a device of the subject. Alternatively, the device transmits a message (e.g., e-mail, SMS text, MMS text, instant message) to the subject with the warning. The device may communicate the warning to the subject, a physician, a pharmacy, a hospital, a healthcare provider and/or an insurance provider.

In some embodiments, the physiological data and exogenous data are correlated on a server. The server may communicate with devices and/or databases to obtain the physiological and exogenous data. In some cases, the server communicates a warning when the correlation is statistically significant. For example, the server may send a warning to the subject or a physician via telephone call, SMS text messaging, email, or other communication protocol. In some examples, the server may communicate a warning to the subject, a physician, a pharmacy, a hospital, a healthcare provider and/or an insurance provider.

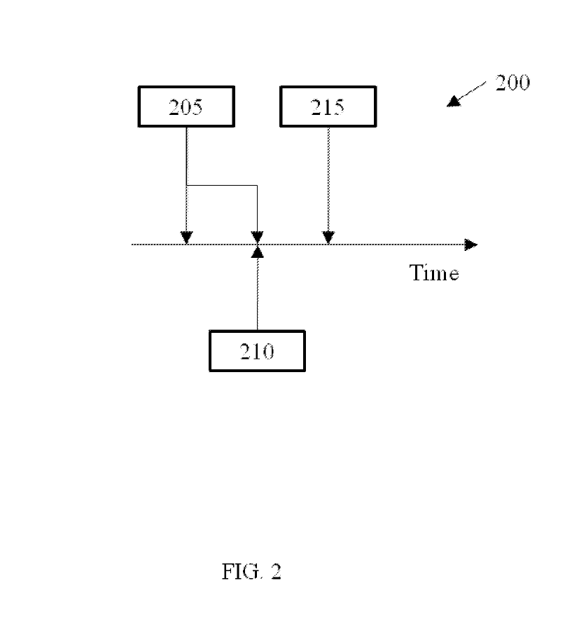

FIG. 2 is a plot illustrating a method 200 for monitoring the health or well-being of a subject. The figure shows various operations as a function of time (x-axis). Each of the operations may be implemented by a health monitoring system having one or more processors, as described herein. In a first step 205, the health monitoring system collects exogenous data. The exogenous data relates to a geographic location of the subject. In an example, the exogenous data includes pollen concentration, temperature and barometric pressure at the geographic location. In a second step 210, the subject visits the geographic location. In some cases, the exogenous data is collected prior to the subject's visit to the geographic location. In other cases, the exogenous data is collected during the subject's visit to the geographic location. In other cases, the exogenous data is collected prior to and at the time of the subject's visit to the geographic location. This enables the subject to determine the effect of the subject's environment on the health or well-being of the subject.

The geographic location may be characterized by geographic coordinates, which may be collected with the aid of the health monitoring system. The health monitoring system may use a global positioning system or a peripheral device (e.g., Smart phone or tablet PC having a GPS module) for measuring the subject's geographic location.

In a third step 215, physiological data and/or personal behavior data are collected. The order of these data collection steps can be reversed, or be in any order. The order can be event driven, and/or preset. Based on any one of these data collection steps, a trigger/threshold event could trigger the other data collection steps. The physiological data may be collected with the aid of a point of service device or system, as described herein. The personal behavior data may be collected with the aid of a data mining system (or server), or a server having data mining software.

Next, the health monitoring system correlates the subject's geographic location with the exogenous data collected in step 205 and the personal behavior and/or physiological data collected in step 215. In an example, the system determines whether any environmental conditions at the geographic location have impacted the health of the subject, or may impact the health of the subject. For instance, if the measurements in step 215 indicate that the subject is sick and the exogenous data from step 205 indicates a high concentration of a pathogen, then the system determines that the subject may be sick from exposure to the pathogen. The system then provides the subject an assessment of the subject's condition. This may enable the subject to seek a targeted remedy that is geared toward treating the sickness.

In some situations, the health monitoring system provides a warning to the subject based on the exogenous data measured in step 205. In such a case, the system may or may not use the personal behavior and/or physiological data from step 215. In an example, from the exogenous data of step 205 the system determines that the geographic location has a higher than normal concentration of a particular pathogen. At the time of the subject's visit to the geographic location or after the visit (step 210), the system warns the subject if the concentration of the pathogen presents the subject with a statistically significant chance of becoming sick or exhibiting an identifiable (or measurable) physiological condition. This may advantageously enable the subject to seek preventative measures, such as, for example, vitamins or dietary supplements, to help prevent the physiological condition.

### Devices and Systems

In other embodiments, devices and systems for providing health management and/or monitoring to a subject are provided. Health monitoring devices and systems provided herein may include hardware and software for implementing methods provided in various embodiments. Examples of hardware include one or more processors, chipsets, storage locations (memory, hard disk), network interfaces, graphic cards, displays, power supplies, and buses.

In some embodiments, a health monitoring system comprises a computer system configured to correlate, with the aid of one or more processors, geolocation data of a the subject with any two of physiological data, exogenous data and personal behavior data, thereby aiding in diagnosis, prognosis and/or treatment of a disease condition of said subject.

In some instances, geolocation data is obtained with the aid of a geolocation system on or associated with said subject. In an example, the geolocation system uses wireless triangulation or a global positioning system (GPS). The geolocation system may be configured to obtain exogenous data and/or physiological data from the subject. In an example, the geolocation data is obtained by a point of service system having a global position system (GPS). The geolocation system may be part of, or operatively coupled to, a point of service system.

In some situations, the computer system is operatively coupled to a health management device configured to obtain physiological data from a subject. The health management device may include a geolocation module for collecting geolocation data. The geolocation module may include a GPS.

Alternatively, the geolocation data is collected with the aid of a geolocation module in a housing of the health monitoring system. In some cases, the computer system of the health monitoring system is included in a housing of the health monitoring system. The housing may include one or more bays or ports for enabling a user to include various modules to aid in collecting one or more of physiological data, exogenous data and personal behavior data.

In some embodiments, geolocation data is obtained with the aid of a geolocation system on or associated with the subject. In some situations, the geolocation system includes multiple devices. In an example, the device is a portable electronic device in proximity to the subject such that the measured location of the device corresponds to the location of the subject. The device may be a portable electronic device the subject carries for other purposes. For example, the device may be a Smart phone, such as an iPhone or Android-enabled phone, capable of gathering geolocation data, such as with the aid of a GPS module of the device. The device may be an iPad or other portable computing device, such as a watch capable of gathering geolocation data.

In some instances, data is collected with the aid of multiple devices, such as, for example, a first device capable of gathering geolocation data. The first device may be, for example, a watch-like device configured to be attached to a wrist of the subject or embedded in the subject's clothing, a patch configured to be attached to the body of the subject, or a pill configured to be ingested by the subject. The first device may be capable of communicating with a second device that is configured to transmit the geolocation data to a server. In an example, the second device is the subject's phone or laptop. The second device may transmit the geolocation data to a server that correlates the data with physiological data and exogenous data. Alternatively, the geolocation system may comprise three, four or more devices.

In another example, the multiple devices may include a first device capable of gathering physiological information. The first device may be a particle (or a plurality of particles) that circulates the subject's bloodstream and relays physiological data to the second device that is in proximity to the subject's body. The particles may have diameters between about 1 nanometer (nm) and 500 micrometers (microns), or 10 nm and 50 microns. If a plurality of particles are used, the particles may communicate with one another through a network interface of the particles. The second device may be configured to collect geolocation data, such as with the aid of a GPS module of the device or via wireless triangulation. The second device collects physiological data from the first device and transmits the physiological data and geolocation data to a server for data processing (i.e., correlation). In some situations, however, the second device collects physiological and, in some cases, exogenous data, and then correlates the geolocation data with any one, two, or three of the exogenous data, physiological data and personal behavior data. Personal behavior data may be collected by the device, such as with the aid of a network interface that enables the second device to search the Internet or an intranet, or with the aid of a server that provides personal behavior data to the second device.

In some embodiments, the health monitoring system is configured to collect any two of physiological data, exogenous data and personal behavior data. Such information may be collected either directly by the health monitoring system, such as with the aid of sensors of the health monitoring system, or with the aid of peripheral devices or systems having sensors for collecting the information, or both by the health monitoring system and peripheral systems. In addition, the health monitoring system may include a communications interface for bringing the health monitoring system in communication with peripheral devices and/or systems that provide personal behavior and exogenous data.

The computer system may be configured to correlate geolocation data of the subject with any two or any three of physiological data, exogenous data and personal behavior data. In some cases, the correlation includes mathematically relating any changes or patterns in the subject's physiological data with information gleaned from exogenous data and personal behavior data. The personal behavior data in some cases may supplement exogenous data. For example, a network status update by the subject as to the temperature at a geolocation (e.g., “It was 10° C. in New York last night”) may provide the temperature (exogenous data) at the geolocation. In such a case, additional exogenous data as to the temperature at the geolocation may not be required.

In some embodiments, a health management and/or monitoring device comprises a housing, and a geolocation module and a point of service module within the housing. The geolocation module is configured to obtain geolocation data at one or more geographic locations of the subject. The point of service module is configured to detect the concentration of an analyte in a biological sample of the subject at the one or more geographic locations.

In some embodiments, a health management device can collect a sample from a subject and process the sample. The same device or a different device can collect exogenous data (e.g., temperature, environmental sample, etc.).

In some situations, the health management device further comprises an exogenous data module for obtaining exogenous data. The exogenous data module may be configured to interface with other systems for collecting data of or relating to exogenous data. In an example, the exogenous data module comprises a network interface for enabling the device to communicate with one or more servers configured to collect exogenous data of or related to the one or more geographic locations of the subject, and to make the exogenous data available to the device. The one or more servers may include data mining hardware and software, such as software configured to search the Internet or predetermined web sites (e.g., “weather.com”) on the internet to find exogenous data.

In some situations, the geolocation module comprises a global positioning system (GPS). In other situations, the geolocation module comprises hardware and software for providing the geolocation of a subject with the aid of triangulation, such as with the aid of a plurality of wireless access points.

In some embodiments, a health monitoring system comprises a health management device and a server operatively linked to the health management device. The health management device comprises i) a geolocation module configured to obtain geolocation data, the geolocation data including geographic locations of a subject, and ii) a point of service module configured to obtain physiological data from the subject. The server is configured to collect the geolocation data and physiological data from the health management device. The server is also configured to correlate, with the aid of a processor, the geolocation data with the physiological data and the exogenous data, the exogenous data of or related to environmental conditions at the geographic locations.

The system may include one or more sensors configured to detect the exogenous data. In an example, the system comprises a thermocouple for measuring environmental temperature, a barometer for measuring atmospheric pressure, and a psychrometer or hygrometer for measuring humidity. Additional sensors may be configured to measure environmental factors (such as radiation), agents, chemicals, bodies, and/or other particulates.

In some cases, the health monitoring system is configured to generate health information related to the subject. The health information may relate to past, present or a future (predicted) health condition of the subject.

In some embodiments, devices and systems described herein include a user interface. In some embodiments, the user interface is a graphical user interface (GUI) configured to display to the subject one or more of i) the geolocation data, ii) the physiological data, and iii) the location-based physiological history of the subject.

The user interface may be provided to a subject by way of a display of the health management system. The display may be a capacitive or resistive touch display. In some situations, the user interface includes a camera for video or still images, a microphone for capturing audible information (e.g., a subject's voice), speakers for providing audible information, and a projector for displaying images and/or video on a predetermined viewing surface.

In some embodiments, the location-based physiological history of a subject is generated by a computer program (or software) that correlates the geolocation data of the subject with physiological data and exogenous data. The computer program may be on a home computer, a server, or the computer of a healthcare provider, such as a physician. In some cases, the computer program is run on a server, which may send the location-based physiological history to another server or computer for analysis. The analysis may generate information to aid in diagnosis, prognosis and/or treatment of a disease condition. In some cases, the analysis is performed with the aid of computer-implemented method running on a computer system having one or more processors. In other cases, the analysis is performed by the subject's physician after the location-based physiological history is generated by the computer system.

Some embodiments provide a non-transitory computer readable medium comprising machine-executable code implementing a method for generating a location-based physiological history of a subject to aid in diagnosis, prognosis and/or treatment of a disease condition. The method comprises generating, with the aid of a processor, a location-based physiological history of said subject by correlating geolocation data of said subject with any one, two, or all of physiological data, exogenous data and personal behavior data.

In some embodiments, non-transitory computer readable media are provided comprising machine-executable code implementing a method for generating a location-based physiological history of a subject to aid in diagnosis, prognosis and/or treatment of a disease condition. In some embodiments, the method comprises generating, with the aid of a processor, a location-based physiological history of the subject by correlating geolocation data of the subject with physiological data and exogenous data. Alternatively, the method may correlate geolocation data of the subject with physiological data and personal behavior data. In some cases, the method correlates geolocation data with physiological data, exogenous data and personal behavior data.

In some embodiments, the machine-executable code further comprises a method for analyzing the location-based physiological history of a subject to aid in diagnosis, prognosis, treatment of a disease or condition and/or the provision of advice pertaining to medical and associated lifestyle decision making In some instances, the analysis methods include: time-series analysis, survival analysis and/or pattern recognition. In some cases, the machine-executable code utilizes classification (e.g., support vector machines), clustering (e.g., hierarchical clustering, k-nearest neighbor), regression (e.g., neural networks), and/or probabilistic graphical models (e.g., Bayesian and Markov networks, collaborative filtering ensemble methods, and image analysis).

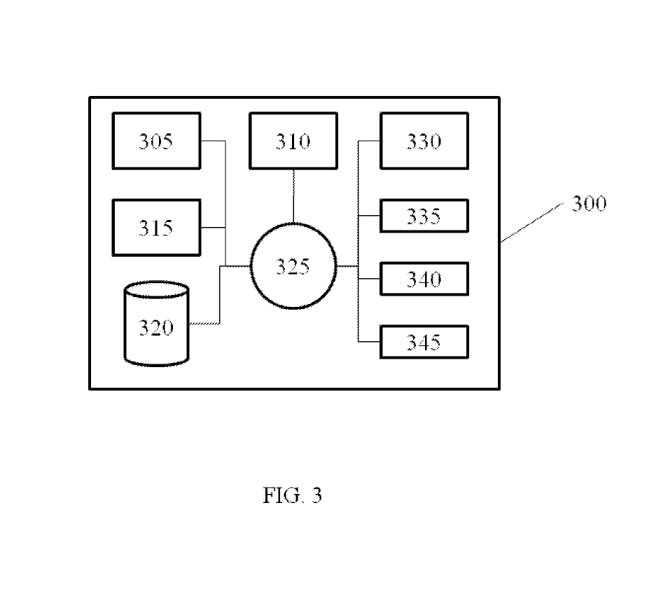

FIG. 3 schematically illustrates a health management device 300 for implementing the methods provided herein. The health management device 300 includes memory 305, display 310, network interface 315, hard disk (or other data repository) 320, processor 325, sample collection and processing module 330, first sensor 335, second sensor 340 and third sensor 345.

The processor 325 may be a central processing unit (CPU). In some cases, the device 300 includes multiple processors.

The first sensor 335 may be configured to collect a first exogenous data, the second sensor 340 may be configured to collect a second exogenous data, and the third sensor 345 may be configured to collect a third exogenous data. The first, second and third exogenous data may be selected from pollen concentration, allergen concentration, pathogen concentration, temperature, air pressure, humidity, dew point, wind speed and/or strength, sun strength, ultraviolet (“UV”) index or other measureable environmental parameters. In an example, the first sensor is a thermocouple, the second sensor is a barometer, and the third sensor is a psychrometer or hygrometer for measuring humidity.

In some embodiments, the third sensor 345 is configured to measure a physiological parameter of the subject, such as, for example, body temperature, heart rate, blood pressure, breathing rate, perspiration level, or capacitance (or resistance). The third sensor in such circumstances may be a thermocouple for temperature measurements or an accelerometer for vibration measurements, which may be correlated with the heart rate of the subject.

The sample collection and processing module 330 is configured to collect a fluid or tissue sample from the subject. The sample collection and processing module may be configured to (a) perform at least one sample preparation procedure selected from the group consisting of sample processing, centrifugation, magnetic separation, and chemical processing, and (b) at least one or multiple types of assays selected from the group consisting of immunoassay, nucleic acid assay, receptor-based assay, cytometric assay, colorimetric assay, enzymatic assay, electrophoretic assay, electrochemical assay, spectroscopic assay (e.g., mass spectrometry, infrared spectroscopy, x-ray photoelectron spectroscopy), chromatographic assay, microscopic assay, topographic assay, calorimetric assay, turbidmetric assay, agglutination assay, radioisotope assay, viscometric assay, coagulation assay, clotting time assay, protein synthesis assay, histological assay, culture assay, osmolarity assay, and/or other types of assays or combinations thereof

The display 310 may be configured to present a user interface to the subject, such as a graphical user interface (GUI). The GUI may be configured to display to the subject the geolocation data, the physiological, personal behavior data, exogenous data, and/or the location-based physiological history of the subject generated by the device 300. The GUI may include the option to view a variety of information. In some examples, the GUI displays exogenous data, such as the current temperature, wind speed and/or strength, UV index and/or weather forecast. The GUI may also deliver alerts or warnings to the user, based on the location-based physiological history and/or reminders. For example, the GUI may remind the user to upload information it collects if the device does communicate to the server wirelessly, or the GUI may remind the user to follow a treatment plan.

In some embodiments, the health management device 300 communicates with other health management devices 300 to share or collection information or data. For instance, at least a subset of a plurality of health management devices can collect exogenous data and provide the exogenous data for use by the plurality health management devices. In some situations, data is available for use by devices that have been authorized to use the data.

In some situations, at least a subset of a plurality of health management devices have network access, and other health management devices may obtain network access through the subset of the plurality of health management devices. In an example, health management devices connect to one another through a Bluetooth (or other peer-to-peer connectivity). Each health management device may then transmit or download information from a network with the aid of the network connectivity of the subset of the plurality of health management devices.

In some embodiments, a health management and/or monitoring system comprises a device for collecting geolocation data and, in some cases, physiological and/or exogenous data, and a server operatively coupled to the device for correlating the geolocation data with any two of physiological data, personal behavior data and exogenous data.

FIG. 4 schematically illustrates a health management or monitoring system 400. The system comprises a health management device 405 and a server 410. The health management device 405 may include a geolocation module 415 configured to obtain geolocation data and a point of service module 420 configured to obtain physiological data from the subject. The device 405 may include an exogenous data module for collecting exogenous data from the location. In some cases, health management device 405 is operatively coupled to the server 410, such as by way of a network interface (e.g., wired or wireless interface) of the health management device 405. The server 410 may be configured to collect the geolocation and/or physiological data from the health management device 405. In some situations, the server 410 is configured to correlate, with the aid of a central processing unit (“CPU”), the geolocation data with physiological data, personal behavior data and/or exogenous data. In some cases, the server 410 correlates, with the aid of the processor, the geolocation data with the physiological data and personal behavior data. In other cases, the server 410 correlates, with the aid of the processor, the geolocation data with the exogenous data and personal behavior data. In other cases, the server correlates, with the aid of the processor, the geolocation data with physiological data, exogenous data and personal behavior data.

In some embodiments, the geolocation module 415 and the point of service module 420 are disposed in a housing of the device 405. In other embodiments, the one or both of the geolocation module 415 and point of service module 420 are located in separate devices, but they may be operatively coupled to the device 405, such as with the aid of a communications module of the device 405. The device 405 may also communicate with other devices, such as, for example, a Smart phone, laptop, tablet computer device or home computer.

In an example, the point of service module 420 obtains physiological data from another device, such as a patch to measure heart rate or temperature. In some situations, the point of service module obtains physiological data from a blood pressure monitor, a blood glucose monitor, a scale and/or other medical devices. The point of service module may communicate (e.g., wirelessly) with other devices to obtain the physiological data.

In some cases, the server 410 obtains exogenous data of or relating to environmental conditions at the location from an exogenous data system 425, which may include a device and/or database for collecting and providing exogenous data. The exogenous data system 425 may be disposed in the location, or may be located remotely from the location but include sensors (or other measurements systems) in the location. The server 410 may obtain such information from a database regularly, or it may access the database, as required, to obtain environmental conditions relating to the location.

Geolocation data and, in some cases, exogenous data, physiological data and/or personal behavior data, is collected by the device 405 and transmitted to the server 410 for analysis, including correlation. The server 410 correlates, with the aid of a processor, the geolocation data with the physiological data, personal behavior data and/or exogenous data.

The server 410 correlates the data to generate a location-based physiological history of the subject. The health management system 400 may be configured to generate health information related to the subject. The information may include the location-based physiological history of the subject. In some situations, the information may include an analysis of the location-based physiological history and/or aid in diagnosis, prognosis and/or treatment of a disease condition. The location-based physiological history may be analyzed on the server 410 in order to provide information to aid in diagnosis, prognosis, treatment of a disease condition, and/or provide information for a health monitoring system. Such information and/or the location-based physiological history may be transmitted by the server 410 to a cloud 430. A subject and/or health care provider may access the cloud 430 and obtain the analysis and/or the location-based physiological history on the subject's personal computer and/or a computer or system of a healthcare provider 435. Alternatively, the information and/or the location-based physiological history may be transmitted directly to the personal computer of a subject, a physician, and/or a healthcare provider 435 from the cloud 430.

In other examples, the health management device 405 includes an exogenous data module for obtaining exogenous data. The module may detect pollen concentration, pathogen concentration, allergen concentration, temperature, wind speed and/or strength, UV index, humidity, weather and/or other information of or relating to the environment. In some cases, the exogenous data module communicates wirelessly to obtain the exogenous data. For example, the exogenous module may collect the data from one or more other devices. In some situations, the module collects this information from other devices on or associated with the subject. In other situations, the module collects this information from devices not associated with the subject, such as, for example a rain gauge, thermometer, airspeed/wind indicator, anemometer, barometer, UV index meter and/or other devices capable of collecting information of or relating to the environment.

In some embodiments, the health management device 405 comprises a module for obtaining personal behavior data. In an example, this module communicates wirelessly to obtain the personal behavior data. The module may collect the personal behavior data from one or more other devices. In another example, the module collects the personal behavior data from a second device on or associated with the subject, such as, for example, a Smart phone, such as an iPhone or Android-enabled phone, or a tablet PC, such as an iPad. As another example, the personal behavior data is collected with the aid of a computer system for mining the internet for information of or related to the subject, including social network web sites (e.g., Facebook, Linkedin). In some situations, the module collects the personal behavior data from the second device through an application of the second device, for example an iPhone application (“app”) associated with a social network, communications, purchasing history and/or other sources of personal behavior data. The application may search phone usage information, such as, for example, communications histories (e.g., call log, SMS and/or MMS messaging history, e-mail messages, purchasing history and/or social networking data), for example from the subject's use of a Facebook, Twitter or Linkedln application.

In some embodiments, the health management device 405 has a user interface, such as a graphical user interface (GUI). In some situations, the GUI is configured to display to the subject the geolocation data, personal behavior data, exogenous data, physiological and/or the generated location-based physiological history of the subject.

In some instances, the GUI provides a user (e.g., the subject) the option to view information. In some examples, the GUI displays exogenous data, such as the current temperature, wind speed and/or strength, UV index and/or weather forecast. The GUI may also deliver reminders, warnings or alerts to the user based on the location-based physiological history. For example, the GUI may remind the user to upload information it collects if the device 405 is unable to communicate with the server 410, or the GUI may remind the user to follow a treatment plan.

### Reports and Alerts

Systems and methods provided herein can aid in the monitoring, diagnosis, prognosis, and/or treatment of a disease condition of a subject. In some cases, information generated from systems and methods provided herein is used to produce a report (e.g., laboratory report, health report) of a subject. The report may be accessible by a health care provider. In some cases, the report is accessible by one or more health care providers selected by the subject. In such cases, the subject may authorize the subject's one or more health care providers to have access to the report. In an example, a subject under treatment or health monitoring selects a doctor or doctors to view a report generated by a health management system.

The report can provide information that is relevant to the health, lifestyle or well being of the subject. In some situations, the subject can select the information that the subject wishes to make accessible and one or more individuals or entities that the subject wishes to have access to the report. In other cases, however, a health management system provides predetermined access restrictions based on the party or entity intended to receive the report. In an example, the health management system provides a physician of a subject a report that has a greater level of detail than a report provided to an insurance company of the subject.

In some cases, a health management system monitors the health, well-being and/or lifestyle of a subject to determine whether the subject is complying or not complying with rules or instructions, such as instructions from a health care provider. In an example, the health management system monitors a subject's geolocation, exogenous data and personal behavior data to determine whether the subject is refraining from ingesting alcohol, as may be prescribed by the subject's physician. The health management system may alert the subject's physician in the event that the subject has ingested alcohol.

In some embodiments, a health management system monitors the health, well-being and lifestyle of a subject and provides warnings based on the trajectory of (or changes in) in the subject's health, well-being and/or lifestyle. In an example, a subject's physician has instructed the subject to not ingest alcohol. Such instructions are inputted into a database or other data storage medium (e.g., flash memory, hard drive) of a health management system. The health management system determines that based on the physician's instructions the subject is not to ingest alcohol. The health management system monitors the subject's activity. If the health management system determines that the subject has an appreciable likelihood of ingesting alcohol (e.g., the subject is in proximity to a bar and the health management system determines that, based on the subject's spatial trajectory, there is an appreciable likelihood that the subject will enter the bar), then the health management system sends the subject a warning (e.g., “Per your doctor's orders, you cannot ingest alcohol”).

### EXAMPLES

### Example 1

Geolocation data is collected from the subject, including geolocation data from travel to various countries, cities, towns, stores, schools, malls/stores and parks. The method of travel is also collected, e.g., travel by bus, airplane or subway. Further, personal behavior data is collected from the subject. Photos of the environment are taken from a portable electronic device, such as a picture of a crowded train or airport. Information is collected from communications devices, including messages indicating that a friend visited from Europe. Further, information is collected from the subject's social networks (such as, e.g., information from friends and family in Mexico). Physiological data is also collected from the subject and is marked by location and time. Data from other subjects and/or populations can be included in the analysis. This information may further aid in identifying trends and causative factors. The physiological data includes: fever, cough, congestion, age & risk factors and pathogen concentrations in nasal or saliva samples. Medical history and family history are also collected.

Exogenous data is also collected at certain locations/times. The exogenous data includes: number and density of people, number and status of other disease carriers (e.g., mosquitoes) and weather conditions. The data includes weather conditions that may impact pathogen virulence.

The exogenous, physiological, personal behavior and geolocation data are all correlated. The system provides a diagnosis of infectious disease, suggestion of additional tests to be performed, assessment of risk of planned travel and a suggested travel route to minimize risk. The system also prescribes prophylactic, curative and palliative treatments.

### Example 2

Geolocation data is collected from the subject, including geolocation data from travel to various countries, cities, towns, stores, schools, malls/stores, parks. The method of travel is also collected, e.g., travel by bus, airplane or subway. Personal behavior data is collected in the form of a purchase history. The purchase history shows the foods and beverages that the subject has purchased (e.g., red wine).

Physiological data is collected from the subject, including: congestion, cough, itching, swelling, runny eyes, headache, complete blood count and inflammatory markers.

Exogenous data is collected at locations the subject has visited or is visiting. The exogenous data is collected within a period of time at or prior to the subject's visit to the location. The environmental factors are measured, including allergen levels, weather conditions that may impact allergen levels, medications taken by the subject and foods eaten by the subject.

The geolocation, physiological, and exogenous data is correlated. Based on this correlation, the system provides an assessment of likely allergens (e.g., the red wine, or an allergen present at a location the subject visited, a food the subject has eaten), assessment of likely agents that increase sensitivity to allergens, assessment of risk of planned travel, and suggested travel route to minimize risk (e.g., avoiding other areas with similar allergen concentrations). The system also prescribes prophylactic, curative, and palliative treatments (e.g., antihistamine).

### Example 3

Geolocation data is collected from the subject, including geolocation data from travel to various countries, cities, towns, stores, schools, malls/stores, parks. The method of travel is also collected, e.g., travel by bus, airplane or subway.

Personal behavior data is collected, such as purchase history and communications history. The personal behavior data shows that the subject purchased an exercise bike or that the subject is training for a marathon. Physiological data is also collected, including the age, weight, blood pressure, risk factors, genetic and family information, blood glucose and HbAl C, and inflammatory markers of the subject.

The system obtains information relating to the subject's exercise, work schedule and sleep (e.g. the subject spends 7 hours a day in bed, 2 hours at the gym and 9 hours at a workplace). The system also collects information about the subject's medications and diet.

The system correlates the above information to provide suggestions, such as healthy eating locations, changes in lifestyle and additional tests to be performed. The system may also prescribe prophylactic, curative, and palliative treatments.

### Example 4

Geolocation data is collected from the subject, including geolocation data from travel to various countries, cities, towns, stores, schools, malls/stores, parks. The method of travel is also collected, e.g., travel by bus, airplane or subway.

Personal behavior data is collected, including the subject's job title/function and Facebook or other social media status updates.

Physiologic factors are collected, including cancer biomarkers (e.g., PSA, CA-125), complete blood count, inflammatory markers (e.g., CRP, IL-6, TNF-alpha), nausea, headache, age and risk factors. Some of the physiological data is collected with the aid of a point-of-care system, and some is inputted by the subject.

Exogenous data relating to the locations of the subject is collected. The exogenous data includes toxicity levels, weather conditions that could (or may) impact toxicity levels, medications taken and foods eaten.

The system correlates the above data to provide information to assist in medical and associated lifestyle decision making, including assessment of likely toxic exposure, likely agents that increase sensitivity to toxic exposure, and risk of planned travel. The system also provides a suggested route to minimize risk and prescribes prophylactic, curative and/or palliative treatments. The system also suggests additional tests to the subject and the subject's healthcare provider.

### Example 5

A subject visits New York City, in the United States of America. The subject has access to a health management system, as described above. A portable electronic device of the subject has a GPS module, in addition to hardware and software for communicating with the health management system. The portable electronic device of the subject records the subject's location at various points in time in one-minute intervals. The health management system collects exogenous data relating to various locations visited by the subject, or which the subject plans to visit via a predetermined schedule provided by the subject to the health management system. The health management system searches the subject's social networking web sites for status updates. In addition, the health management system receives status updates from the subject by way of the subject's portable electronic device (e.g., with the aid of an app that enables the subject to interact with the system).

From the exogenous data collected by the health management system, the system determines that, at shopping center visited by the subject, several patrons reported getting sick. The system also determines that the subject had indicated on the subject's Facebook profile that the subject was feeling sick after visiting the shopping center. The system then correlates the subject's geolocations (the shopping center) with exogenous data (pathogens at the shopping center) and personal behavior data (status update) to alert the subject that the subject may have contracted a sickness from the subject's visit to the shopping center. The correlation in such a case includes determining that the subject had visited the shopping center having the pathogens, and subsequently using the subject's personal behavior data to determine that the subject has an appreciable likelihood of the subject contracting an illness upon exposure to the pathogen. The subject then seeks treatment targeted at the potential cause of the sickness of the patrons, as may be determined by the subject, a healthcare provider, or the health management system in cases in which the system as access to a network with information relating to the patrons' conditions.

### Example 6

As previously described, geolocation data may be correlated with other types of data. FIG. 5 provides an example of such data correlation.

1) A time series for glucose, CRP, and three main locations (home, work and outside) may be provided.

2) In the example, glucose levels of the subject are higher when outside the subject's home compared to in the subject's home. This correlation may suggest that the food eaten at home is healthier (i.e., lower in sugar), and the subject should modify their diet when eating out in accordance with their physician's guidance.

3) The illustration shows CRP levels of the subject are higher at the place of work compared to other locations. This relationship suggests that factors associated with the work environment are inducing a rapid inflammatory response. For example, exposure to an environmental agent or allergen in the work place may be responsible for this behavior. Collection of exogenous data at the work place could help explain this relationship and lead to recommendations and or treatment measures. In addition, comparison of physiologic data of other co-workers may further establish an environmental factor that similarly affects other subjects.

In some embodiments, methods above, alone or in combination, are implemented with the aid of one or more systems and devices provided in U.S. patent application Ser. No. 13/244,947 to Holmes et al. (“SYSTEMS AND METHODS FOR MULTI-ANALYSIS”), the content of which is incorporated herein in its entirety.

While the above is a complete description of the preferred embodiments of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. The appended claims are not to be interpreted as including means-plus-function limitations, unless such a limitation is explicitly recited in a given claim using the phrase “means for.” It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Also, as used in the description herein and throughout the claims follow, terms of “include” and “contain” are open ended and do not exclude additional, unrecited elements or method steps. Finally, as used in the description herein and throughout the claims that follow, the meanings of “and” and “or” include both the conjunctive and disjunctive and may be used interchangeably unless the context expressly dictates otherwise. Thus, in contexts where the terms “and” or “or” are used, usage of such conjunctions do not exclude an “and/or” meaning unless the context expressly dictates otherwise.

1. A computer-implemented method for generating a location-based physiological history of a subject, comprising:
generating, with the aid of a processor, a location-based physiological history of said subject by correlating geolocation data of said subject with physiological data and exogenous data,
wherein said geolocation data is obtained with the aid of a geolocation system on or associated with said subject, and
wherein said exogenous data is of or related to environmental conditions at a geographic location of said subject.

2. The method of claim 1, wherein said physiological data is obtained with the aid of a point of service system on or associated with said subject.

3. The method of claim 1, wherein said physiological data is obtained at a geographical location of said subject.

4. The method of claim 1, wherein said physiological data comprises at least one of protein concentration, blood pressure, breathing pattern, white blood cell count, red blood cell count, heart rate, body temperature, blood pressure, DNA/RNA expression, drug concentration, skin conductivity, amount of hand tremors, or metabolite concentration.

5. The method of claim 1, wherein said exogenous data is collected before, during, or after said subject's visit to said location.

6. The method of claim 1, wherein said exogenous data comprises at least one of, temperature, air pressure, humidity, dew point, wind speed, food consumed by the subject, or concentration of allergens, pollen, pathogens, carbon monoxide, or toxins.

7. The method of claim 1, wherein said geolocation data is obtained with the aid of a geolocation system on or associated with said subject.

8. The method of claim 7, wherein the geolocation system uses wireless triangulation or a global positioning system (GPS).

9. The method of claim 7, wherein said geolocation system is configured to obtain exogenous data or physiological data from said subject.

10. The method of claim 1, further comprising transmitting said location-based physiological history of said subject to (i) said subject, (ii) a healthcare provider, (iii) an insurance provider, or (iv) a pharmacy.

11. The method of claim 1, further comprising correlating said location-based physiological history of said subject with a location-based physiological history of other subjects.

12. (canceled)

13. The method of claim 1, further comprising correlating said exogenous data with geolocation data, physiological data, and personal behavior data to generate said location-based physiological history, wherein said exogenous data is of or relating to the environment.

14-19. (canceled)

20. The method of claim 13, wherein said personal behavior data is collected from at least one source selected from the group consisting of a social network, the Internet, a communications repository, a retailer, a multimedia repository, a bank, or a credit union.

21. The method of claim 13, wherein said personal behavior data is obtained from a communications device or multimedia device of or associated with said subject.

22. The method of claim 21, wherein said communications device or multimedia device is portable.

23. The method of claim 13, wherein said personal behavior data comprises at least one of social networking data, communications data, purchasing history, or multimedia data.

24. The method of claim 23, wherein said communications data is selected from the group consisting of short message service (SMS) text messaging, multimedia message service (MMS) text messaging, phone conversations, or instant messaging.

25. The method of claim 13, further comprising transmitting said location-based physiological history of said subject to (i) said subject, (ii) a healthcare provider, (iii) an insurance provider, or (iv) a pharmacy.

26. The method of claim 13, further comprising correlating said location-based physiological history of said subject with a location-based physiological history of other subjects.

27-45. (canceled)

46. A method for providing a warning concerning the health of a subject, comprising:
correlating, with the aid of a processor, geolocation data of said subject with physiological data and exogenous data, said exogenous data related to an environmental condition of a location in which said subject resides or plans to visit; and
providing said warning concerning the health of the subject based on said correlation when said correlation is statistically significant,
wherein said physiological data is collected during or subsequent to the visit to said location.

47-52. (canceled)
